(19) United States
(12) Patent Application Publication
(10) Pub. No.: US 2019/0379060 A1
(43) Pub. Date: Dec. 12, 2019

(54) ELECTRODE MATERIAL AND APPLICATION THEREOF

(71) Applicant: SAKAI CHEMICAL INDUSTRY CO., LTD., Sakai-shi, Osaka (JP)

(72) Inventors: Seiichi YANO, Osaka (JP); Hiroshi TSUTSUMI, Osaka (JP); Miho KISHI, Osaka (JP); Akihiro UEMURA, Osaka (JP); Mayu OTA, Osaka (JP)

(21) Appl. No.: 16/486,779

(22) PCT Filed: Feb. 21, 2018
(86) PCT No.: PCT/JP2018/006294

§ 371 Date: Aug. 16, 2019

(30) Foreign Application Priority Data
Mar. 29, 2017 (JP) 2017-065956

(51) Int. Cl. H01M 4/92; H01M 4/88; H01M 4/86

(52) U.S. Cl. CPC H01M 4/925; H01M 4/8605; H01M 4/8817

(57) ABSTRACT

The present invention provides a highly conductive electrode material having high oxygen reduction activity. The present invention also provides an electrode material composition and a fuel cell each containing the electrode material. The present invention relates to an electrode material having a structure containing a noble metal and/or an oxide thereof supported on titanium oxynitride or a composite compound of titanium oxynitride and an oxide of titanium. The titanium oxynitride or the composite compound of titanium oxynitride and an oxide of titanium is in the form of powder. The electrode material has pore diameter distribution satisfying the following features (I) and (II): (I) a ratio (b/a) of a peak area b in a pore diameter range of 50 to 180 nm to a peak area a in a pore diameter range of 0 to 180 nm, calculated from log differential pore volume distribution, being 0.9 or more, and (II) a cumulative pore volume in a pore diameter range of 50 to 180 nm being 0.1 cm³/g or greater.

### TECHNICAL FIELD

The present invention relates to electrode materials and uses thereof. Specifically, the present invention relates to an electrode material, and an electrode material composition and a fuel cell each including the electrode material.

### BACKGROUND ART

Fuel cells are devices that generate electric power by electrochemically reacting fuel such as hydrogen or alcohol with oxygen. They are classified into different types of cells such as polymer electrolyte fuel cells (PEFCs), phosphoric acid fuel cells (PAFCs), molten-carbonate fuel cells (MCFCs), and solid oxide fuel cells (SOFCs), according to factors such as electrolyte and operating temperature. Polymer electrolyte fuel cells, for example, are used as stationary power sources or for fuel cell vehicles, and are thus expected to maintain desired power generation performance for a long period of time.

Polymer electrolyte fuel cells include an ion conductive polymer membrane (ion exchange membrane) as an electrolyte and commonly include a material containing platinum supported on a carbon carrier (Pt/C) as an electrode material. When such polymer electrolyte fuel cells are used in automotive applications, for example, large load fluctuations due to operations such as start and stop may promote oxidation reaction of carbon (C+2H₂O→CO₂+4H⁺+4e⁻). For example, when the potential of the cathode is not lower than 0.9 V, the oxidation reaction of carbon easily proceeds. In this case, platinum aggregates on or separates from the carbon, leading to significant reduction of the fuel cell performance. For such problems, catalysts including titanium, for example, in place of carbon have been proposed in recent years (see, for example, Patent Literature 1 and Patent Literature 2). Furthermore, a technique of using Ti₄O₇ single crystals has been proposed (see Non-Patent Literature 1).

### CITATION LIST

### Patent Literature

Patent Literature 1: JP 2010-40480 A
Patent Literature 2: WO 2011/065471

### Non-Patent Literature

Non-Patent Literature 1: J. R. SMITH, and two other persons, “Electrodes based on Magneli phase titanium oxides: the properties and applications of Ebonex® materials”, J. APPL. ELECTROCHEM, October 1998, Vol. 28, No. 10, pp. 1021-1033

### SUMMARY OF INVENTION

### Technical Problem

A material containing platinum supported on a carbon carrier (Pt/C) is usually used as an electrode material, as described above. However, such a material has a problem of corrosion caused by progress of oxidation of carbon when it is used at high potential, for example. Unfortunately, alternative electrode materials have not been found yet.

For example, the titanium compound disclosed in Patent Literature 1 and the Ti₄O₇ single crystals disclosed in Non-Patent Literature 1 each having high conductivity are possible alternatives to carbon. However, in order for these compounds on which a noble metal such as platinum is supported to be used as an electrode material, the compounds need to be highly active against a catalytic reaction necessary for power generation under conditions where reactant gas is supplied to the electrode. For example, materials used for cathodes need to be highly active against “oxygen reduction reaction (O₂+4H⁺+4e⁻→2H₂O) under conditions where oxygen flows. For high activity, the materials need to have high conductivity and a pore volume that can diffuse reaction gas. The titanium compound in Patent Literature 1 and the titanium compound of Comparative Example 1 described later have a relatively large pore volume, but are not sufficiently active. Also, since Ti₄O₇ is usually synthesized by reducing (deoxidizing) raw material titanium oxide at high temperatures, conventional single-phase Ti₄O₇ compounds are in the form of particle aggregates, failing to have sufficient pore volume.

In view of the current state of the art described above, the present invention aims to provide a highly conductive electrode material having high oxygen reduction activity. The present invention also aims to provide an electrode material composition and a fuel cell each containing the electrode material.

### Solution to Problem

The present inventors have made intensive studies on alternative electrode materials to conventional materials containing platinum supported on a carbon carrier (Pt/C), and have found that an electrode material having a structure containing a noble metal and/or an oxide thereof supported on a powdery titanium oxynitride or a powdery composite compound of titanium oxynitride and an oxide of titanium as a carrier and having predetermined porosity is highly conductive and has excellent oxygen reduction activity. This highly conductive electrode material is an alternative to a conventional electrode material (Pt/C). Thus, they arrived at a solution to the problem, completing the present invention.

That is, one aspect of the present invention relates to an electrode material having a structure containing a noble metal and/or an oxide thereof supported on titanium oxynitride or a composite compound of titanium oxynitride and an oxide of titanium,

the titanium oxynitride or the composite compound of titanium oxynitride and an oxide of titanium being in the form of powder,

the electrode material having pore diameter distribution satisfying the following features (I) and (II):

(I) a ratio (b/a) of a peak area b in a pore diameter range of 50 to 180 nm to a peak area a in a pore diameter range of 0 to 180 nm, calculated from log differential pore volume distribution, being 0.9 or more, and

(II) a cumulative pore volume in a pore diameter range of 50 to 180 nm being 0.1 cm3/g or greater.

The noble metal is preferably at least one metal selected from the group consisting of platinum, ruthenium, iridium, rhodium, and palladium.

The noble metal is preferably platinum.

The electrode material is preferably an electrode material for a polymer electrolyte fuel cell.

Another aspect of the present invention relates to an electrode material composition including the electrode material.

Another aspect of the present invention relates to a fuel cell including an electrode containing the electrode material or the electrode material composition.

Another aspect of the present invention relates to a method for producing an electrode material, including:

(1) firing a raw material containing rutile titanium oxide having a specific surface area of 20 m2/g or greater in an ammonia atmosphere; and

(2) supporting a noble metal and/or an oxide thereof on a product obtained in the step (1) using the product and a noble metal and/or a water-soluble compound thereof.

The step (1) further includes firing in a reducing atmosphere.

### Advantageous Effects of Invention

The electrode material of the present invention is highly conductive and has high oxygen reduction activity. Thus, the electrode material is useful as an electrode material for fuel cells such as polymer electrolyte fuel cells, solar cells, transistors, and display devices such as liquid crystal display panels. In particular, it is useful for polymer electrolyte fuel cells.

### BRIEF DESCRIPTION OF DRAWINGS

FIG. 1 illustrates cumulative pore volume distribution of powders obtained in Examples 1 to 5. The horizontal axis is a pore diameter (dp, unit: nm), and the vertical axis is a cumulative pore volume (Sigma Vp, unit: cm³/g) (the same applies to FIG. 3).

FIG. 2 illustrates log differential pore volume distribution of the powders obtained in Examples 1 to 5. The horizontal axis is a pore diameter (dp, unit: nm), and the vertical axis is a log differential pore volume (the same applies to FIG. 4).

FIG. 3 illustrates cumulative pore volume distribution of powders obtained in Comparative Examples 1 to 3.

FIG. 4 illustrates log differential pore volume distribution of the powders obtained in Comparative Examples 1 to 3.

FIG. 5-1 is an X-ray diffraction pattern of the powder obtained in Example 1.

FIG. 5-2 is a TEM photograph of the powder obtained in Example 1.

FIG. 6-1 is an X-ray diffraction pattern of the powder obtained in Example 2.

FIG. 6-2 is a TEM photograph of the powder obtained in Example 2.

FIG. 7-1 is an X-ray diffraction pattern of the powder obtained in Example 3.

FIG. 7-2 is a TEM photograph of the powder obtained in Example 3.

FIG. 8-1 is an X-ray diffraction pattern of the powder obtained in Example 4.

FIG. 8-2 is a TEM photograph of the powder obtained in Example 4.

FIG. 9-1 is an X-ray diffraction pattern of the powder obtained in Example 5.

FIG. 9-2 is a TEM photograph of the powder obtained in Example 5.

FIG. 10-1 is an X-ray diffraction pattern of the powder obtained in Comparative Example 1.

FIG. 10-2 is a TEM photograph of the powder obtained in Comparative Example 1.

FIG. 11-1 is an X-ray diffraction pattern of the powder obtained in Comparative Example 2.

FIG. 11-2 is a TEM photograph of the powder obtained in Comparative Example 2.

FIG. 12-1 is an X-ray diffraction pattern of the powder obtained in Comparative Example 3.

FIG. 12-2 is a TEM photograph of the powder obtained in Comparative Example 3.

FIG. 13 is a diagram explaining XRD data analysis to identify a crystalline phase.

### DESCRIPTION OF EMBODIMENTS

Preferred embodiments of the present invention are specifically described below, but the present invention is not limited to the following description, and modification may be suitably made without departing from the gist of the present invention.

### 1. Electrode Material

The electrode material of the present invention has a structure containing a noble metal and/or an oxide thereof supported on powdery titanium oxynitride (also referred to as a titanium oxynitride powder) or a powdery composite compound (also referred to as a composite compound powder) of titanium oxynitride and an oxide of titanium.

The composite compound of titanium oxynitride and an oxide of titanium is in a state of a phase mixture of titanium oxynitride and an oxide of titanium. In other words, titanium oxynitride and an oxide of titanium are present as a mixture in each particle of the compound. The phase mixture can be confirmed by XRD analysis.

Titanium oxynitride may be represented by TiOₓN₍₁₋ₓ₎. The ratio between oxygen and nitrogen, that is, the x value, can be determined by X-ray powder diffraction (XRD) analysis for the following reasons. Titanium oxynitride has a structure in which any of nitrogen elements (N) in titanium nitride (TiN) having a NaCl-type crystal structure are replaced by oxygen elements (O) or a structure in which any of oxygen elements (O) in titanium monoxide (TiO) having a NaCl-type crystal structure are replaced by nitrogen elements (N). TiN and TiO show the same X-ray diffraction patterns, but the interatomic distance between Ti atom and N atom and that between Ti atom and O atom in a crystal lattice are different from each other. This difference is identified as a difference in lattice constant. The method for determining the lattice constant and the x value in TiONₓN₍₁₋ₓ₎ by XRD will be specifically described later.

The oxide of titanium is preferably at least one selected from titanium (di)oxide and titanium suboxide. The titanium (di)oxide is preferably of rutile type.

When the titanium oxynitride or the titanium oxynitride in the composite compound of titanium oxynitride and an oxide of titanium is represented as TiOₓN₍₁₋ₓ₎, x is preferably 0.1 or greater and 0.9 or smaller. The titanium oxynitride having x within this range leads to an electrode material in which the properties and the durability are well balanced and thus is advantageous in practical use. The x value is more preferably 0.5 or greater and 0.9 or smaller, still more preferably 0.6 or greater and 0.9 or smaller.

The titanium oxynitride or the composite compound of titanium oxynitride and an oxide of titanium is in the form of powder. Such powdery compounds have good dispersibility and handleability as an electrode material and are thus moldable in any shape. The electrode material itself is preferably in the form of powder.

The titanium oxynitride or the composite compound of titanium oxynitride and an oxide of titanium preferably contains less than 0.2% by mass of metal elements other than Ti. With such an amount, the possibility that the metal elements other than Ti leach out of the electrically conductive material during its use can be sufficiently eliminated. Thus, the properties of the electrode material of the present invention are more effectively exhibited.

Herein, the amount of the metal elements other than Ti can be determined by X-ray fluorescence (XRF) analysis or inductive coupling plasma (ICP) analysis.

The term “metal elements” encompasses metalloid atoms such as silicon.

One or more noble metals and/or their oxides may be supported on the titanium oxynitride or the composite compound of titanium oxynitride and an oxide of titanium. The noble metal is preferably, but not limited to, at least one metal selected from the group consisting of platinum, ruthenium, iridium, rhodium, and palladium because such noble metals enable an easy and stable catalytic reaction at an electrode. In particular, platinum is more preferred.

The noble metal may form an alloy depending on production conditions. The noble metal may partially or entirely form an alloy with titanium for possible further improvement in oxygen reduction activity.

The supported amount of the noble metal and/or oxide thereof is preferably 1 to 40 parts by weight in terms of the noble metal element relative to 100 parts by weight of the titanium oxynitride or the composite compound of titanium oxynitride and an oxide of titanium (when two or more of the noble metals and/or their oxides are used, the total supported amount preferably falls within the above range). The noble metal and/or oxide thereof in such an amount is more finely dispersed, thus further improving the properties of the electrode material. The supported amount of the noble metal and/or oxide thereof is more preferably 5 to 35 parts by weight, still more preferably 8 to 35 parts by weight.

The amount of the supported noble metal and/or its oxide may be determined using, for example, a scanning X-ray fluorescence analyzer (ZSX Primus II available from Rigaku Corporation) as described in the examples below.

In addition to the noble metal and/or oxide thereof, the electrode material may further contain at least one metal selected from the group consisting of nickel, cobalt, iron, copper, and manganese.

The electrode material has pore diameter distribution satisfying the following feature (I).

(I) A ratio (b/a) of a peak area b in a pore diameter range of 50 to 180 nm to a peak area a in a pore diameter range of 0 to 180 nm, calculated from log differential pore volume distribution, is 0.9 or more.

For further increase in oxygen reduction activity, the ratio (b/a) of the peak areas is preferably 0.90 or more, more preferably 0.92 or more, still more preferably 0.95 or more.

Although the reason why the above relation in the pore diameter distribution affects the properties of the electrode material is unknown, the following possibilities are conceivable. In the pores having a size of less than 50 nm, water produced does not sufficiently diffuse, remaining in the pores. This presumably makes it difficult for oxygen which is a reactant involved in the oxygen reduction reaction or an electrolyte which transfers protons to enter the pores. For this reason, the oxygen reduction activity may decrease in the presence of many pores having a size of less than 50 nm.

The electrode material has pore diameter distribution also satisfying the following feature (II).

(II) A cumulative pore volume in a pore diameter range of 50 to 180 nm is 0.1 cm3/g or greater.

The electrode material satisfying this cumulative pore volume allows reactant gas supplied to the electrode to sufficiently diffuse. For further increase in oxygen reduction activity, the cumulative pore volume is preferably 0.2 cm³/g or greater, still more preferably 0.25 cm³/g or greater.

The porosity (the ratio b/a and the cumulative pore volume described above) as used herein can be determined by the methods described in the examples below. The cumulative pore volume is a value obtained by accumulating, as the pore diameter decreases, the pore volume of pores with the pore volume of pores having a size of 180 nm.

The electrode material preferably has an area specific activity per specific surface area of the noble metal and/or oxide thereof of 80 A/m² or higher. Higher area specific activity indicates higher oxygen reduction activity and better electrochemical properties. The area specific activity is more preferably 100 A/m² or higher, still more preferably 120 A/m² or higher, particularly preferably 150 A/m² or higher.

The area specific activity as used herein can be determined by the method described in the examples below.

The electrode material preferably has a specific surface area of 10 m²/g or greater. Such an electrode material has much better electrochemical properties. The specific surface area is more preferably 15 m²/g or greater, still more preferably 20 m²/g or greater, particularly preferably 25 m²/g or greater.

The specific surface area (also referred to as “SSA”) as used herein means a BET specific surface area.

The BET specific surface area refers to the specific surface area obtained by the BET method which is one of methods for measuring the specific surface area. The specific surface area refers to the surface area per unit mass of an object.

The BET method is a gas adsorption method in which a specific surface area is determined from the amount of gas particles such as nitrogen adsorbed onto solid particles. Herein, the specific surface area can be determined by the method described in the examples below.

### 2. Electrode Material Composition

The electrode material composition of the present invention contains the electrode material of the present invention. The preferred embodiment of the electrode material contained in the electrode material composition is the same as that of the above-described electrode material.

### 3. Production Method

The method for producing an electrode material or an electrode material composition of the present invention may be any method. The electrode material of the present invention can be easily and simply produced, for example, by a method including (1) firing a raw material containing rutile titanium oxide having a specific surface area of 20 m²/g or greater in an ammonia atmosphere; and (2) supporting a noble metal and/or an oxide thereof on a product obtained in the step (1) using the product and a noble metal and/or a water-soluble compound thereof. Another aspect of the present invention relates to such a method for producing an electrode material. This production method may optionally further include one or more other steps for usual powder production, as needed.

### 1) Step (1)

The step (1) uses a raw material containing rutile titanium oxide having a specific surface area of 20 m²/g or greater. Use of the titanium oxide results in fewer impurities that may be present during the production. In addition, titanium oxide, which is easily available, is advantageous in terms of stable supply. The above-described powdery titanium oxynitride can be efficiently obtained by the step (1).

The term “titanium oxide” as used herein refers to titanium oxide (also referred to as “titanium dioxide”) available on regular market, and specifically refers to what is called “titanium oxide” in qualitative tests such as X-ray diffraction analysis.

If the electrode material contains titanium oxide other than rutile titanium oxide (e.g., anatase titanium oxide), a ratio (b/a) of a peak area b in a pore diameter range of 50 to 180 nm to a peak area a in a pore diameter range of 0 to 180 nm, calculated from log differential pore volume distribution, is small.

The titanium oxide has a specific surface area of 20 m²/g or greater. This allows the powdery titanium oxynitride to be efficiently obtained. The specific surface area is preferably 30 m²/g or greater, more preferably 40 m²/g or greater, still more preferably 50 m²/g or greater.

When the raw material is a mixture (material mixture) of two or more components, the mixture can be obtained by mixing the components by a usual mixing method, preferably by a dry method. In other words, the raw material mixture is preferably a dry mixture.

Each raw material component may be of one kind or two or more kinds.

The step (1) includes firing the raw material in an ammonia atmosphere (also referred to as ammonia firing). In this case, the raw material may be directly fired. When the raw material contains a solvent, the solvent may be removed by, for example, filtration before firing.

The concentration of the ammonia is preferably within the range of 5 to 100 vol %, more preferably 50 vol % or higher, still more preferably 75 vol % or higher, particularly preferably 100 vol %.

The firing temperature is preferably 500° C. or higher and lower than 1100° C., for example. This allows the electrode material satisfying the above-described porosity to be efficiently obtained, and allows the electrode material to have both high specific surface area and high conductivity. The firing temperature is more preferably 600° C. or higher, still more preferably 650° C. or higher, while more preferably 1000° C. or lower, still more preferably 950° C. or lower.

The firing temperature as used herein means the highest temperature reached in the firing.

The firing time, that is, the retention time at the firing temperature, is preferably 5 minutes to 100 hours, for example. When the firing time is in the above range, the reaction proceeds more sufficiently, resulting in excellent productivity. The firing time is more preferably 30 minutes or longer, still more preferably 60 minutes or longer, particularly preferably 2 hours or longer, while more preferably within 24 hours, still more preferably within 10 hours.

When the atmosphere is cooled after the completion of firing, the atmosphere may be mixed or replaced with a gas other than ammonia (e.g., nitrogen gas). Before or after ammonia firing, reduction firing may be performed in the presence of hydrogen gas or other gas. Thereby, the composite compound of titanium oxynitride and an oxide of titanium can be obtained. The firing temperature, firing time, and atmospheric gas concentration of the reduction firing are preferably within the same ranges as for the ammonia firing.

When reduction firing is performed, the raw material may also contain a reduction aid. Examples of the reduction aid include titanium metal, titanium hydride, and sodium borohydride.

### 2) Step (2)

The step (2) uses the product obtained in the step (1) (powdery titanium oxynitride) and a noble metal and/or a water-soluble compound thereof. The method may include one or more other steps such as crushing, washing with water, and classification, as needed, before the step (2). Other steps are not limited.

Here, the step (1) further including firing in a reducing atmosphere (also referred to as reduction firing) before or after obtaining the powdery titanium oxynitride provides a composite compound of titanium oxynitride and magneli titanium suboxide and/or rutile titanium oxide. When the step (2) uses the resulting composite compound, the electrode material having a structure containing a noble metal and/or an oxide thereof supported on the composite compound can be efficiently obtained. The electrode material (electrode material composition) is also obtainable by providing the step (2) with a mixture of the powdery titanium oxynitride obtained in the step (1) and separately produced powdery titanium suboxide (particularly preferably Ti₄O₇) and/or rutile titanium oxide.

Non-limiting examples of the reducing atmosphere include a hydrogen (H₂) atmosphere, a carbon monoxide (CO) atmosphere, a nitrogen (N₂) atmosphere, and a mixed gas atmosphere of hydrogen and inert gas. In particular, nitrogen atmosphere or hydrogen atmosphere is preferred in terms of efficiency. The firing temperature and firing time of the reduction firing are preferably within the same ranges as for the ammonia firing.

In the step (2), the product(s) obtained in or through the step (1) (which indicate(s) the powdery titanium oxynitride obtained in the step (1), the powdery composite compound of titanium oxynitride and an oxide of titanium, or the mixture of the powdery titanium oxynitride and separately produced titanium suboxide and/or rutile titanium oxide, the same applies hereinafter) is preferably mixed with a noble metal and/or a water-soluble compound thereof (hereinafter, also collectively referred to as a noble metal compound). Specifically, a slurry containing the product(s) obtained in or through the step (1) is preferably mixed with a solution of a noble metal compound or a dispersion of a noble metal to prepare a liquid mixture. This allows the noble metal and/or an oxide thereof to be more highly dispersed and to be supported.

Each component may be of one kind or two or more kinds.

The method for mixing the components, that is, the method for preparing the liquid mixture, is not limited. For example, the solution of a noble metal compound or the dispersion of a noble metal is added to the slurry containing the product(s) obtained in or through the step (1) while the slurry is stirred in a container, followed by mixing under stirring. The temperature at the time of addition is preferably 40° C. or lower. The mixture is preferably heated to a predetermined temperature while mixing by stirring. The mixing may be performed by stirring using a stirrer with a stir bar, or using a stirring device equipped with a stirring blade such as a propeller-type or paddle-type stirring blade.

The slurry may further contain a solvent.

The solvent may be of any type such as water, an acidic solvent, an organic solvent, or a mixture thereof. Examples of the organic solvent include alcohol, acetone, dimethylsulfoxide, dimethylformamide, tetrahydrofuran, and dioxane. Examples of the alcohol include water-soluble monohydric alcohols such as methanol, ethanol, and propanol; and water-soluble diols or polyols such as ethylene glycol and glycerol. The solvent is preferably water, more preferably ion-exchanged water.

The amount of the solvent is preferably, but not limited to, for example, 100 to 100000 parts by weight relative to 100 parts by weight of the solids content of the product(s) obtained in or through the step (1) (when two or more products are used, the total solids content thereof). This allows the electrode material to be more simply obtained. The amount of the solvent is more preferably 500 to 50000 parts by weight, still more preferably 1000 to 30000 parts by weight.

The slurry may further contain additives such as acid, alkali, chelate compounds, organic dispersants, and polymer dispersants. These additives are expected to improve the dispersibility of the carrier contained in the slurry.

The solution of a noble metal compound and the dispersion of a noble metal are not limited as long as they contain a noble metal and/or a water-soluble compound thereof. Examples include solutions of inorganic salts (e.g., sulfate, nitrate, chloride, and phosphate) of a noble metal; solutions of organic acid salts (e.g., acetate and oxalate) of a noble metal; and dispersions of a nano-sized noble metal. In particular, solutions such as a chloride solution, a nitrate solution, a dinitrodiammine nitric acid solution, and a bis(acetylacetonato) platinum (II) solution are preferred. The noble metal is as described above, and platinum is particularly preferred. Thus, the solution of a noble metal is particularly preferably an aqueous chloroplatinic acid solution or an aqueous dinitrodiammine platinum nitric acid solution. In terms of reactivity, an aqueous chloroplatinic acid solution is most preferred.

The amount of the solution of a noble metal compound used is preferably, but not limited to, for example, 0.01 to 50 parts by weight in terms of the noble metal element relative to 100 parts by weight of the total solids content of the product(s) obtained in or through the step (1), for example. This allows the noble metal and/or oxide thereof to be more finely dispersed. The amount is more preferably 0.1 to 40 parts by weight, still more preferably 10 to 30 parts by weight.

The step (2) may include reduction, surface treatment, and/or neutralization of the liquid mixture, as needed. For example, for reduction, the liquid mixture is preferably mixed with a reducing agent to adequately reduce the noble metal compound. For surface treatment, the liquid mixture is preferably mixed with a surfactant to optimize surfaces of the carrier and the noble metal compound. For neutralization, the liquid mixture is preferably mixed with a basic solution. When two or more of reduction, surface treatment, and neutralization are performed, the reducing agent, the surfactant, and the basic solution may be added separately in any order or may be added together.

Non-limiting examples of the reducing agent include hydrazine chloride, hydrazine, sodium borohydride, alcohol, hydrogen, sodium thiosulfate, citric acid, sodium citrate, L-ascorbic acid, formaldehyde, ethylene, and carbon monoxide, with hydrazine chloride being preferred. The amount of the reducing agent added is preferably, but not limited to, 0.1 to 1 times the molar equivalent of the noble metal contained in the liquid mixture.

The surfactant may be, but not limited to, for example, an anionic surfactant, a cationic surfactant, an amphoteric surfactant, or a nonionic surfactant. Examples of the anionic surfactant include carboxylate anionic surfactants such as soap, sulfonate anionic surfactants such as sodium lauryl sulfate, and sulfate anionic surfactants such as lauryl sulfate sodium salts. Examples of the cationic surfactant include quaternary ammonium salt cationic surfactants such as polydimethyldiallylammonium chloride and amine salt cationic surfactants such as dihydroxyethylstearylamine. Examples of the amphoteric surfactant include amino acid amphoteric surfactants such as methyl laurylaminopropionate and betaine amphoteric surfactants such as lauryl dimethyl betaine. Examples of the nonionic surfactant include polyethylene glycol nonionic surfactants such as polyethylene glycol nonylphenyl ether, polyvinyl alcohol, and polyvinylpyrrolidone. The amount of the surfactant is preferably, but not limited to, 0.01 to 10 parts by weight, more preferably 0.1 to 5.0 parts by weight, relative to the total 100 parts by weight of the product(s) obtained in or through the step (1).

Non-limiting examples of the basic solution include an aqueous NaOH solution, an aqueous NH₃ solution, and an aqueous sodium carbonate solution, with an aqueous NaOH solution being preferred. The neutralization temperature during neutralization is preferably 60° C. to 100° C., more preferably 70° C. to 100° C.

In the step (2), moisture and by-products are preferably removed from the liquid mixture (which may be one reduced, surface-treated, and/or neutralized, as needed, as described above). The moisture and by-products may be removed by any method, and are preferably removed by filtration, washing with water, drying, or evaporation under heating, for example.

The by-products are preferably removed by washing with water. Residual by-products, if present in the electrode material, may leach into a system during operation of a polymer electrolyte fuel cell, for example, which may result in poor power generation characteristics or system damage. The method for washing with water may be any method capable of removing a water-soluble substance not supported on the titanium oxynitride or the composite compound of titanium oxynitride and an oxide of titanium from the system. Examples include filtration, washing with water, and decantation. Here, by-products are preferably removed by washing with water until the conductivity of the washing water is 10 μS/cm or less. More preferably, by-products are removed by washing with water until the conductivity is 3 μS/cm or less.

Also in the step (2), a powder obtained after removal of moisture and by-products from the liquid mixture is more preferably fired. This allows a noble metal or its oxide having a low degree of crystallinity not suitable for exertion of oxygen reduction activity to have a degree of crystallinity suitable for exertion of oxygen reduction activity. The degree of crystallinity is considered to be sufficient if peaks derived from a noble metal or its oxide can be observed in XRD. When the dried powder is fired, it is preferably fired in a reducing atmosphere. The reducing atmosphere is as described above. A nitrogen atmosphere or a hydrogen atmosphere is particularly preferred. The firing temperature is preferably, but not limited to, 500° C. to 900° C., for example. The firing time is preferably, but not limited to, 30 minutes to 24 hours, for example. The concentration of the atmospheric gas is preferably within the same range as for the ammonia firing. This allows the noble metal or its oxide and the titanium oxynitride or the composite compound of titanium oxynitride and an oxide of titanium to be made suitable to express oxygen reduction activity.

The step (2) is particularly preferably a step including reducing the liquid mixture containing the product(s) obtained in or through the step (1) and a noble metal compound, followed by filtering and drying the reduced mixture to obtain a powder, and firing the powder.

### 4. Uses

The electrode material and the electrode material composition of the present invention have high electrical conductivity comparable to or higher than that of a conventional material containing platinum supported on a carbon carrier and also have high oxygen reduction activity. Such an electrode material and an electrode material composition can be suitably used in electrode material applications for fuel cells, solar cells, transistors, and display devices such as liquid crystal display panels, particularly preferably used in electrode material applications for polymer electrolyte fuel cells (PEFCs). In a preferred embodiment of the present invention, each of the electrode material and the electrode material composition is an electrode material for polymer electrolyte fuel cells. The present invention encompasses a fuel cell including an electrode that contains the electrode material or the electrode material composition.

### 5. Fuel Cell

The electrode material and the electrode material composition of the present invention are suitably used in electrode material applications for fuel cell electrode materials, particularly suitably used in electrode material applications for polymer electrolyte fuel cells (PEFCs). In particular, they are useful as alternatives to a conventional material containing platinum supported on a carbon carrier. Such an electrode material is suitable for both a positive electrode (also referred to as “air electrode”) and a negative electrode (also referred to as “fuel electrode”), and is also suitable for both a cathode (positive electrode) and an anode (negative electrode). In a preferred embodiment of the present invention, a polymer electrolyte fuel cell includes the electrode material or the electrode material composition of the present invention.

### EXAMPLES

Specific examples are provided below to describe the present invention in detail. The present invention is not limited to these examples. The “%” and “wt %” mean “% by weight (% by mass)” unless otherwise specified. The following describes the measurement methods of the physical properties.

1. X-Ray Diffraction Pattern (XRD Analysis: Determination of x Value in TiOₓN₍₁₋ₓ₎)

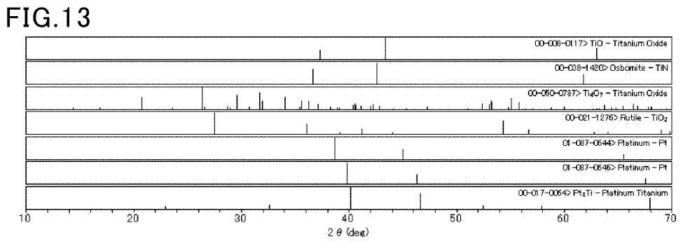

An X-ray powder diffraction pattern was measured using an X-ray diffractometer (trade name: “RINT-TTR3” available from Rigaku Corporation) under the following conditions. The crystalline phase was identified with reference to the diagram explaining XRD data analysis illustrated in FIG. 13.

X-ray source: Cu-Kα ray
Measurement range: 2θ=10° to 60°
Scanning speed: 5°/min

### Voltage: 50 kV

### Current: 300 mA

The x value in TiOₓN₍₁₋ₓ₎ was determined as follows.

The diffraction pattern measured was analyzed using X-ray powder diffraction pattern comprehensive analysis software JADE7 J attached to the X-ray diffractometer. A lattice constant a [Å] was thus obtained from the peaks corresponding to: a crystal system: Cubic; a space group: Fm-3m (225); and the plane indices: (hk1)=(111), (200), (220). This operation was conducted after smoothing or background removal as needed. The lattice constant of TiOₓN₍₁₋ₓ₎ is a value between the lattice constant of TiO and the lattice constant of TiN. Thus, the proportion x of O atoms was determined by proportional calculation, specifically, determined from a ratio between a difference in lattice constant between TiOₓN₍₁₋ₓ₎ and TiN and a difference in lattice constant between TiO and TiN. The lattice constant was obtained with the lattice constant of TiO (JCPDS card No. 08-1117) of 4.1770 [Å] and the lattice constant of TiN (JCPDS card No. 38-1420) of 4.2417 [Å].

### 2. Porosity

A measurement sample (powder obtained in each example) was allowed to stand at 200° C. under a reduced pressure of 1.0×10⁻² kPa for 10 hours, and then subjected to measurement of cumulative pore volume distribution and differential pore volume distribution by a N₂ adsorption method using BEL-SORP mini II (BEL Japan Inc.).

The pore volume was measured from the larger pore diameter side toward the smaller pore diameter side to determine a cumulative pore volume in a pore diameter range of 180 nm to 50 nm.

Based on the resulting differential pore volume distribution, the differential pore volume was divided by the differential value of the logarithm of the pore diameter to determine a log differential pore volume, and the log differential pore volume was plotted against the average pore diameter in each pore diameter region to create log differential pore volume distribution.

The graph prepared as above was printed on a sheet of PPC paper RJ: (Mitsubishi Paper Industries Co., Ltd.), necessary peaks were cut out from the printed sheet, the cut-out pieces of the paper were weighed to determine the area ratio (i.e., the ratio (b/a) of the peak area b in a pore diameter range of 50 to 180 nm to the peak area a in a pore diameter range of 0 to 180 nm).

### 3. TEM Image Analysis

The transmission electron micrograph (also referred to as a TEM picture or a TEM photograph) of each sample was taken using a transmission electron microscope (field emission transmission electron microscopy JEM-2100F available from JEOL).

### 4. Supported Amount of Platinum

The amount of platinum in each sample was measured using a scanning X-ray fluorescence spectrometer (ZSX Primus II available from Rigaku Corporation), and the supported amount of platinum was calculated.

### 5. Specific Surface Area (BET-SSA)

In accordance with JIS Z 8830 (2013), the sample was heated at 200° C. for 60 minutes in a nitrogen atmosphere, and then the specific surface area was measured using a specific surface area meter (trade name: “Macsorb HM-1220” available from Mountech Co., Ltd.).

### 6. Area Specific Activity

The area specific activity was evaluated by the following procedures. Higher area specific activity indicates higher conductivity.

### (1) Production of Working Electrode

Each sample to be measured was mixed with a 5% by weight perfluorosulfonic acid resin solution (Sigma-Aldrich Japan), isopropyl alcohol (Wako Pure Chemical Industries, Ltd.), and ion-exchange water, followed by ultrasonic dispersion. Thus, a paste was prepared. The paste was applied to a rotating glassy carbon disk electrode and sufficiently dried. The rotating electrode after the drying was served as a working electrode.

### (2) Measurement of Electrochemical Surface Area (ECSA)

A rotating electrode device (trade name: “HR-502” available from Hokuto Denko Corporation) was connected to an automatic polarization system (trade name: “HZ-5000” available from Hokuto Denko Corporation). The electrode with a measurement sample obtained as described above was served as a working electrode, and a platinum electrode and a reversible hydrogen electrode (RHE) were served as a counter electrode and a reference electrode, respectively.

In order to clean the electrode with a measurement sample, the electrode was subjected to cyclic voltammetry from 0.05 V to 1.2 V while an electrolyte solution (0.1 mol/l aqueous perchloric acid solution) was bubbled with argon gas at 25° C. Then, cyclic voltammetry was performed from 1.2 V to 0.05 V at a sweep rate of 50 mV/sec using the electrolyte solution (0.1 mol/l aqueous perchloric acid solution) saturated with argon gas at 25° C.

Subsequently, the electrochemical surface area was calculated using the following mathematical formula (i) from the area of a hydrogen adsorption wave profile obtained with sweeping (charge of hydrogen adsorption: QH (μC)). In the formula (i), “210 (μC cm²)” is the adsorbed charge per unit active area of platinum (Pt).

### (3) Measurement of Area Specific Activity

A rotating electrode device (trade name: “HR-502” available from Hokuto Denko Corporation) was connected to an automatic polarization system (trade name: “HZ-5000” available from Hokuto Denko Corporation). The electrode with a measurement sample obtained as described above was served as a working electrode, and a platinum electrode and a reversible hydrogen electrode (RHE) were served as a counter electrode and a reference electrode, respectively.

In order to clean the electrode with a measurement sample, the electrode was subjected to cyclic voltammetry from 0.05 V to 1.2 V while an electrolyte solution (0.1 mol/l aqueous perchloric acid solution) was bubbled with argon gas at 25° C. Then, cyclic voltammetry was performed from 0.05 V to 1.21 V at a sweep rate of 10 mV/sec using the electrolyte solution (0.1 mol/l aqueous perchloric acid solution) saturated with argon gas at 25° C.

Thereafter, the electrolyte solution was bubbled and saturated with oxygen, and cyclic voltammetry was performed from 0.05 V to 1.21 V at a sweep rate of 10 mV/s at four levels of electrode rotational speed (1600, 900, 400, 100 rpm).

The current value at 0.8V vs. RHE was plotted for each rotation speed so that the activation control current value was determined, and the current value was divided by ECSA to obtain the area specific activity (A/m²) per m² of platinum.

### 7. Measurement of Median Size (D50) of Powder

The median size was measured using a laser diffraction/scattering particle size distribution analyzer (LA-950 available from Horiba, Ltd.).

In Table 1, D50 for “Before Pt is supported” is D50 of a carrier on which no noble metal (platinum) is supported, and D50 for “After Pt is supported” is D50 of each powder finally obtained in the following examples.

### Example 1

First, 2.0 g of rutile titanium oxide (trade name: “STR-100N” available from Sakai Chemical Industry Co., Ltd., specific surface area: 100 m²/g) was put in an alumina boat, and then heated to 800° C. at 300° C./hr under a 100% ammonia flow of 400 ml/min in an atmospheric furnace. The temperature was kept at 800° C. for six hours, and then lowered to room temperature by natural cooling. Thus, a titanium oxynitride powder (t1) was obtained.

Then, 0.60 g of the titanium oxynitride powder (t1) and 128 g of ion-exchanged water were weighed into a beaker, and mixed by stirring. Thus, a titanium oxynitride slurry was obtained.

In a separate beaker, 1.3 g of an aqueous chloroplatinic acid solution (Tanaka Kikinzoku Kogyo, 15.343% based on platinum) was diluted with 8.0 g of ion-exchanged water. Then, 0.053 g of hydrazine chloride (trade name: “Hydrazine Dihydrochloride” available from Tokyo Chemical Industry Co., Ltd.) was added to the diluted solution, followed by mixing under stirring (the resulting product is referred to as an “aqueous solution mixture”).

While the titanium oxynitride slurry was stirred, the entire aqueous solution mixture prepared in the separate beaker was added thereto, followed by mixing under stirring with the mixture heated to and maintained at a liquid temperature of 70° C. Further, 7.0 mL of a 1 N aqueous sodium hydroxide solution was added, followed by mixing under stirring. The mixture was heated to and maintained at a liquid temperature of 70° C. for one hour, followed by filtration, washing with water, drying to evaporate the entire moisture. Thus, a powder (p1) was obtained.

A 0.5-g portion of the powder (p1) was put in an alumina boat, and heated to 510° C. at 600° C./hr under a nitrogen flow of 200 ml/min in an atmospheric furnace. The temperature was kept at 510° C. for one hour, and then lowered to room temperature by natural cooling. Thus, Example 1 Powder was obtained.

### Example 2

An amount of 0.72 g of the titanium oxynitride powder (t1) obtained in Example 1 and 128 g of ion-exchanged water were weighed into a beaker, and mixed by stirring. Thus, a titanium oxynitride slurry was obtained.

In a separate beaker, 0.54 g of an aqueous chloroplatinic acid solution (Tanaka Kikinzoku Kogyo, 15.343% based on platinum) was diluted with 3.2 g of ion-exchanged water. Then, 0.022 g of hydrazine chloride (trade name: “Hydrazine Dihydrochloride” available from Tokyo Chemical Industry Co., Ltd.) was added to the diluted solution, followed by mixing under stirring (the resulting product is referred to as an “aqueous solution mixture”).

While the titanium oxynitride slurry was stirred, the entire aqueous solution mixture prepared in the separate beaker was added thereto, followed by mixing under stirring with the mixture heated to and maintained at a liquid temperature of 70° C. Further, 3.0 mL of a 1 N aqueous sodium hydroxide solution was added, followed by mixing under stirring. The mixture was heated to and maintained at a liquid temperature of 70° C. for one hour, followed by filtration, washing with water, drying to evaporate the entire moisture. Thus, a powder (p2) was obtained.

The subsequent procedures were performed as in Example 1, except that the powder (p2) was used instead of the powder (p1) obtained by the production method in Example 1. Thus, Example 2 Powder was obtained.

### Example 3

First, 2.0 g of rutile titanium oxide (trade name: “STR-100N” available from Sakai Chemical Industry Co., Ltd., specific surface area: 100 m²/g) was put in an alumina boat, and then heated to 920° C. at 300° C./hr under a 100% ammonia flow of 400 ml/min in an atmospheric furnace. The temperature was kept at 920° C. for four hours, and then lowered to room temperature by natural cooling. Thus, a titanium oxynitride powder (t2) was obtained.

The subsequent procedures were performed as in Example 2, except that the titanium oxynitride powder (t2) was used instead of the titanium oxynitride powder (t1) obtained by the production method in Example 2. Thus, Example 3 Powder was obtained.

### Example 4

First, 2.0 g of rutile titanium oxide (trade name: “STR-100N” available from Sakai Chemical Industry Co., Ltd., specific surface area of 100 m²/g) was dry-mixed with 0.1 g of titanium metal (trade name: “titanium, powder” available from Wako Pure Chemical Industries, Ltd.). Then, the mixture was heated to 900° C. at 300° C./hr in a hydrogen atmosphere. The temperature was maintained at 900° C. for 150 minutes, and then lowered to room temperature by natural cooling. Thus, a Ti₄O₇ powder was obtained.

Then, 1.7 g of the Ti₄O₇ powder was dry-mixed with 0.9 g of the titanium oxynitride powder (t1). Thus, a powder (t4) was obtained.

The subsequent procedures were performed as in Example 2, except that the powder (t4) was used instead of the powder (t1) obtained by the production method of the powder (p2) in Example 2. Thus, a powder (p4) was obtained.

A 0.5-g portion of the powder (p4) was put in an alumina boat, and heated to 560° C. at 600° C./hr under a 100% hydrogen flow of 200 ml/min in an atmospheric furnace. The temperature was kept at 560° C. for one hour, and then lowered to room temperature by natural cooling. Thus, Example 4 Powder was obtained as an electrode material composition.

### Example 5

First, 2.0 g of rutile titanium oxide (trade name: “STR-100N” available from Sakai Chemical Industry Co., Ltd., specific surface area: 100 m²/g) and 0.3 g of titanium metal (trade name: “Titanium, Powder” available from Wako Pure Chemical Industries) were dry-mixed. Then, the mixture was put in an alumina boat, and heated to 700° C. at 300° C./hr under a 100% hydrogen flow of 400 ml/min in an atmospheric furnace. The temperature was kept at 700° C. for two hours, and was then increased to 750° C. at 300° C./hr. Thereafter, the supply of hydrogen was stopped. The temperature was kept at 750° C. for three hours under a 100% ammonia flow of 400 ml/min, and then lowered to room temperature by natural cooling. Thus, a composite compound powder (t5) was obtained.

The subsequent procedures were performed as in Example 4, except that the composite compound powder (t5) was used instead of the composite compound powder (t4) obtained by the production method in Example 4. Thus, Example 5 Powder was obtained.

### Comparative Example 1

First, 2.0 g of anatase titanium oxide (trade name: “SSP-25” available from Sakai Chemical Industry Co., Ltd., specific surface area: 270 m²/g) was put in an alumina boat, and heated to 700° C. at 300° C./hr under a 100% ammonia flow of 400 ml/min in an atmospheric furnace. The temperature was kept at 700° C. for six hours, and then lowered to room temperature. Thus, a titanium oxynitride powder (t6) was obtained.

The subsequent procedures were performed as in Example 2, except that the titanium oxynitride powder (t6) was used instead of the titanium oxynitride powder (t1) obtained by the production method in Example 2. Thus, Comparative Example 1 Powder was obtained.

### Comparative Example 2

First, 3.3 g of the Ti₄O₇ powder obtained by the production method in Example 4 was dry-mixed with 0.9 g of the titanium oxynitride powder (t6) obtained by the production method in Comparative Example 1. Thus, a powder (t7) was obtained.

The subsequent procedures were performed as in Example 4, except that the powder (t7) was used instead of the powder (t4) obtained by the production method in Example 4. Thus, Comparative Example 2 Powder was obtained.

### Comparative Example 3

Comparative Example 3 Powder was obtained as in Example 4, except that the Ti₄O₇ powder obtained by the production method in Example 4 was used instead of the powder (t1) obtained by the production method in Example 2.

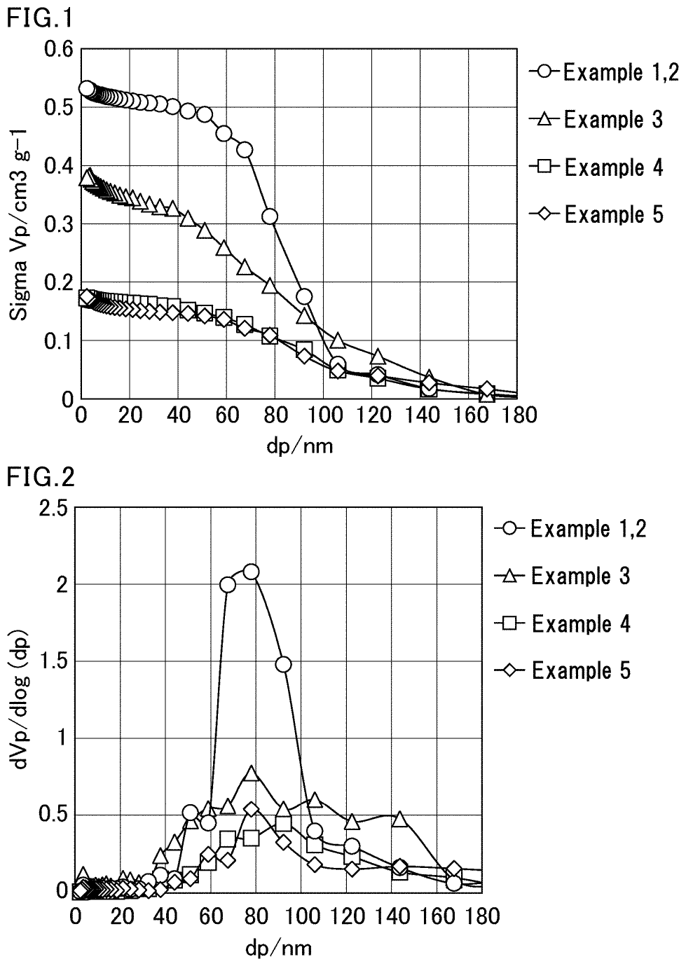

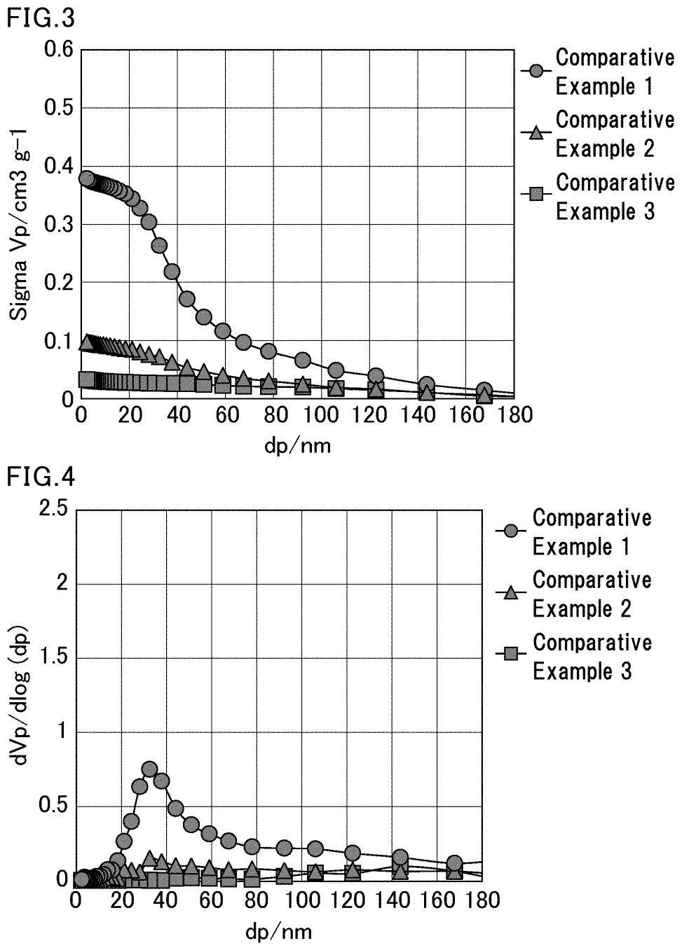

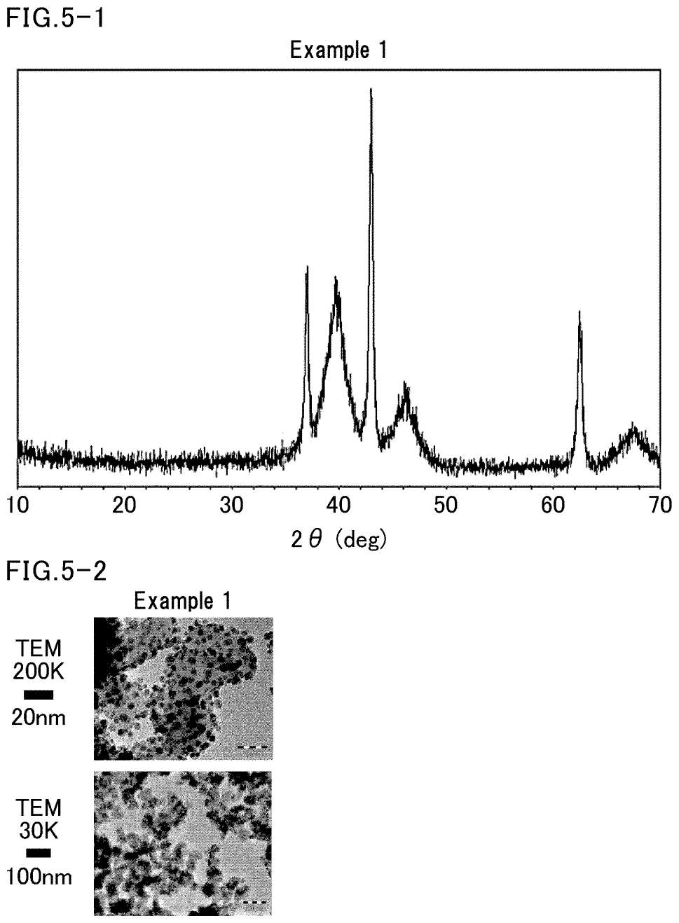

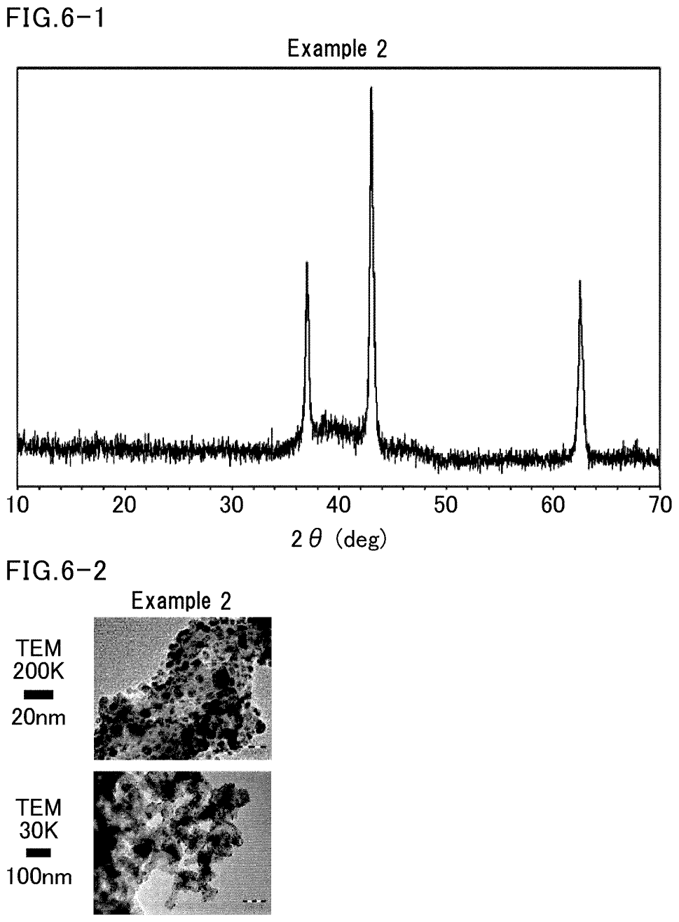

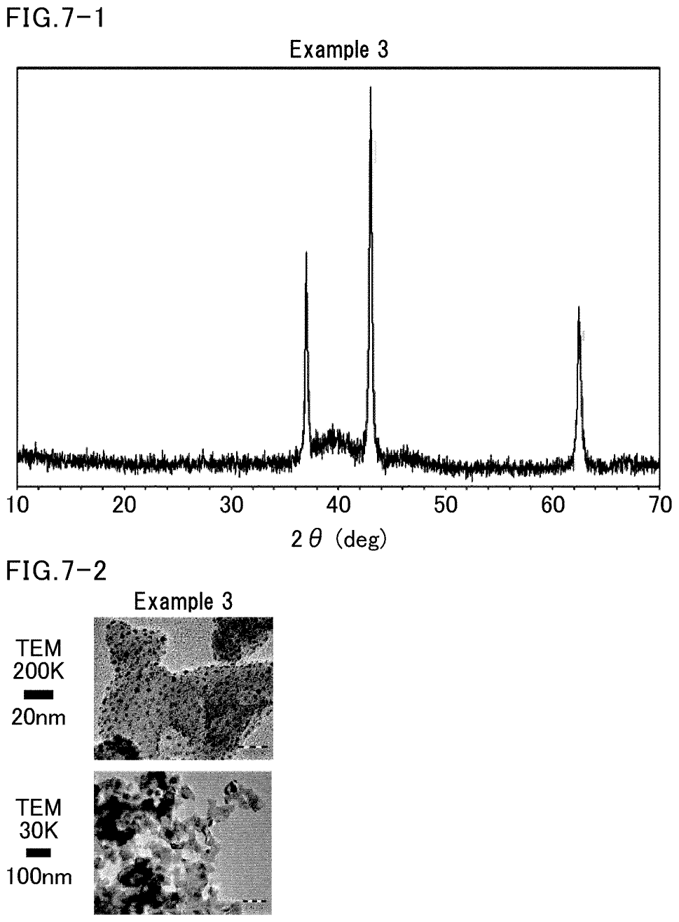

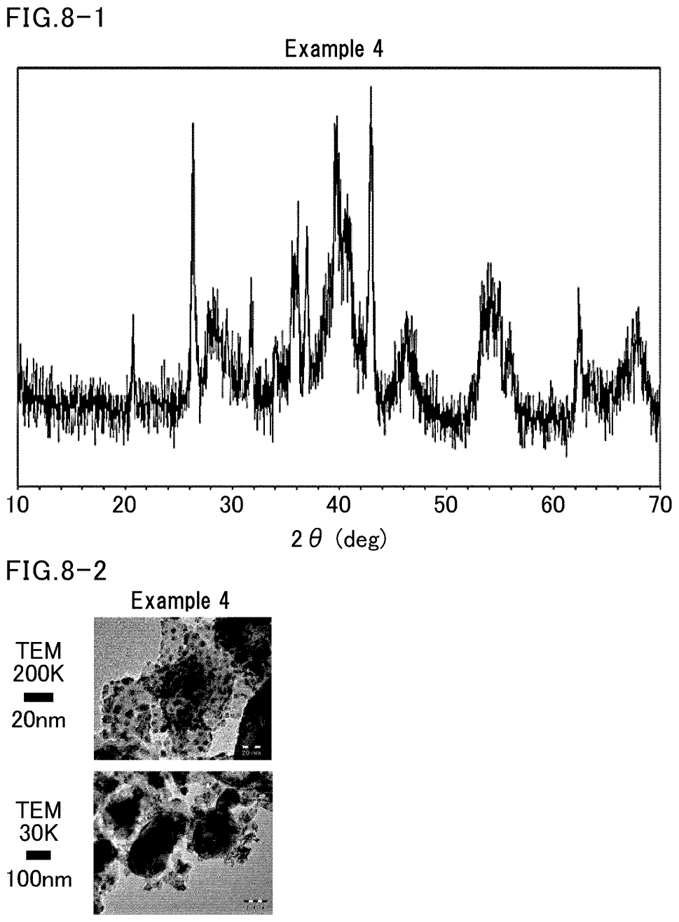

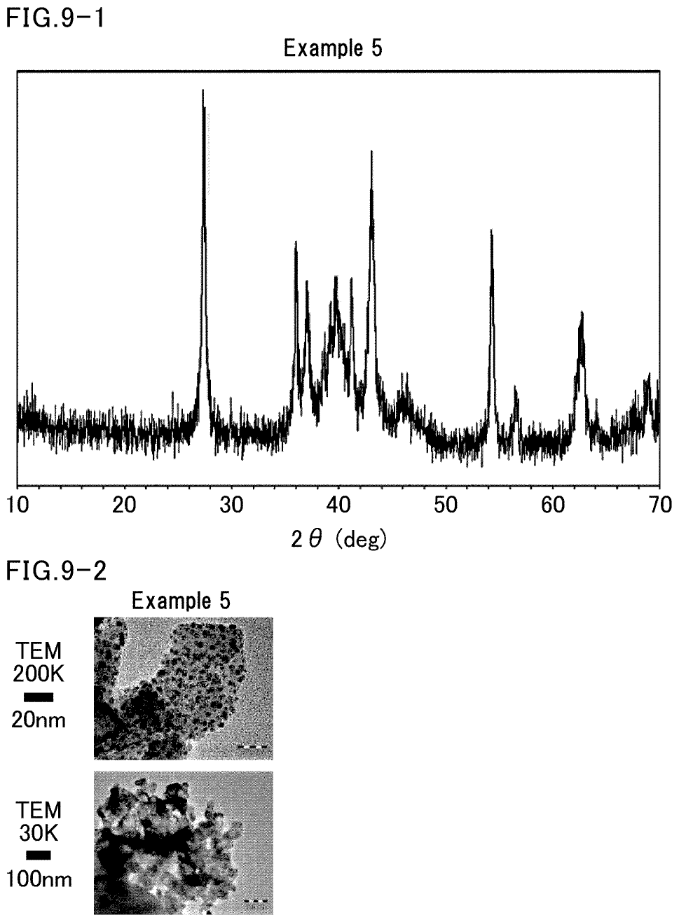

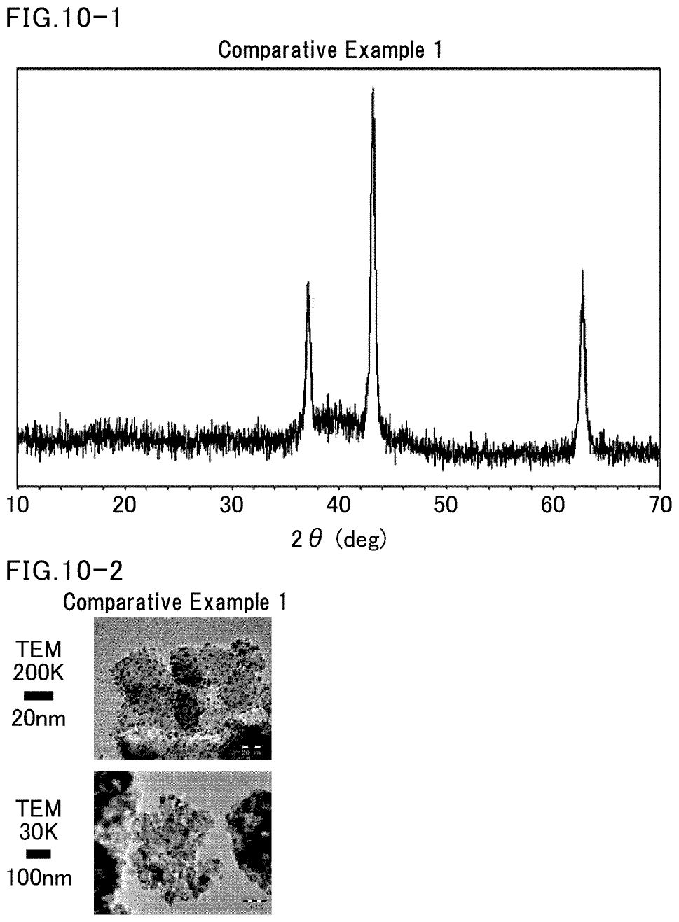

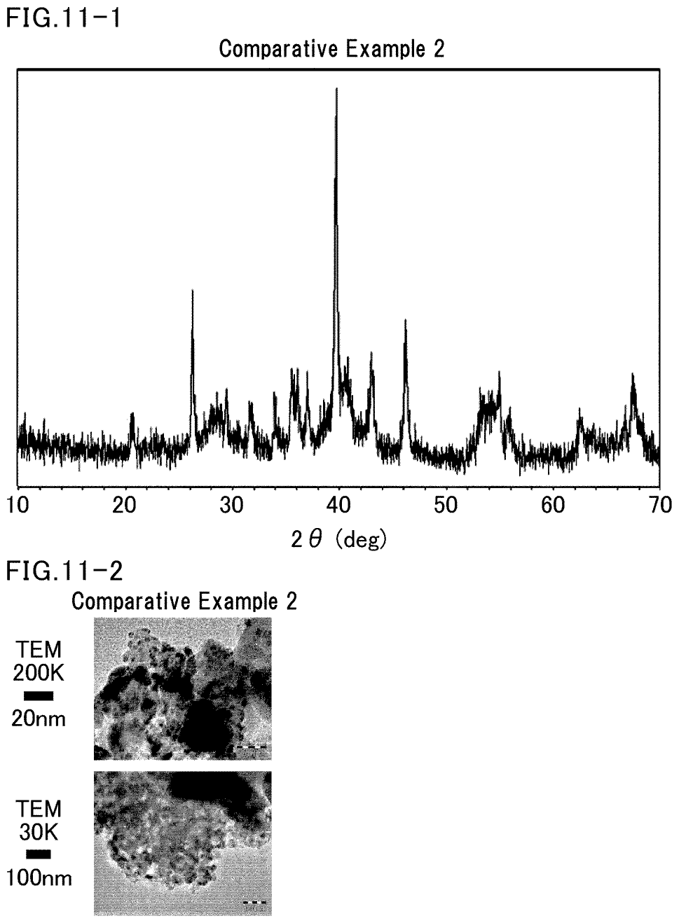

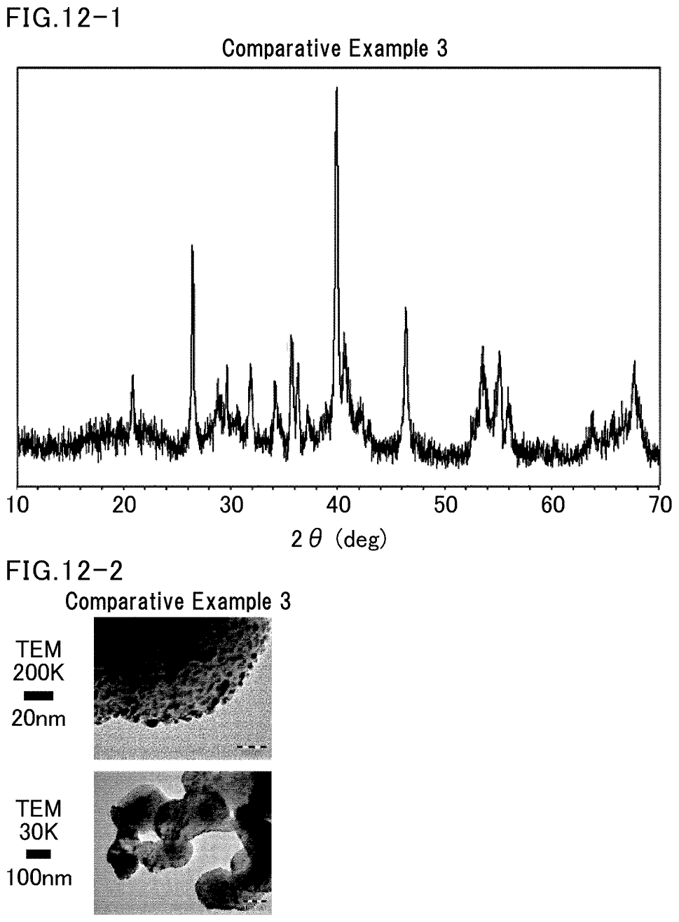

The powders (samples) obtained in Examples 1 to 5 and Comparative Examples 1 to 3 were analyzed and evaluated by the above-described methods. The results are shown in Table 1 and FIGS. 1 to 13.

TABLE 1

| | | Porosity | | | | | | | | |
|---|---|---|---|---|---|---|---|---|---|---|
| | | Cumulative | Area ratio | | | | | Area | | |
| | | volume | (b/a) from | D50 [μm] | | Supported | | specific | TiOₓN₍₁₋ₓ₎ | |
| | | of pores from | log differential | Before | After | amount | | activity | lattice | |
| | XRD analysis | 50 to 180 nm | pore volume | Pt is | Pt is | of Pt | BET-SSA | [A/m²Pt] | constant | |
| | Formulation | [cm³/g] | distribution | supported | supported | [wt %] | [m²/g] | (0.8 V) | [Å] | x |
| Example 1 | Pt | 0.487 | 0.96 | 5.21 | 5.82 | 31.5 | 39.8 | 312 | 4.198 | 0.67 |
| | Titanium oxynitride | | | | | | | | | |
| Example 2 | Pt | 0.487 | 0.96 | 5.21 | 6.31 | 10.5 | 39.8 | 201 | 4.195 | 0.72 |
| | Titanium oxynitride | | | | | | | | | |
| Example 3 | Pt | 0.289 | 0.90 | 5.36 | 5.08 | 10.3 | 27.6 | 173 | 4.201 | 0.63 |
| | Titanium oxynitride | | | | | | | | | |
| Example 4 | Pt | 0.142 | 0.95 | 8.23 | — | 9.8 | 12.7 | 118 | 4.193 | 0.76 |
| | Titanium oxynitride | | | | | | | | | |
| | Ti₄O₇ | | | | | | | | | |
| Example 5 | Pt | 0.225 | 0.92 | 8.83 | — | 11.3 | 26.7 | 284 | 4.184 | 0.89 |
| | Titanium oxynitride | | | | | | | | | |
| | Rutile (phase mixture) | | | | | | | | | |
| Compar- | Pt | 0.140 | 0.60 | — | — | 9.9 | 49.5 | 67 | 4.196 | 0.70 |
| ative | Titanium oxynitride | | | | | | | | | |
| Example 1 | | | | | | | | | | |
| Compar- | Pt | 0.047 | 0.73 | — | — | 9.7 | 14.0 | 67 | 4.183 | 0.91 |
| ative | Titanium oxynitride | | | | | | | | | |
| Example 2 | Ti₄O₇ | | | | | | | | | |
| Compar- | Pt | 0.024 | 0.93 | — | — | 11.5 | 5.8 | Not | — | — |
| ative | Ti₄O₇ | | | | | | | measurable | | |
| Example 3 | | | | | | | | | | |

The results of the examples and the comparative examples as shown in Table 1 demonstrate the following.

The powders obtained in Examples 1 to 3 are electrode materials each including powdery titanium oxynitride composed of titanium, nitrogen, and oxygen as a carrier and having a ratio b/a of 0.9 or more and a cumulative pore volume in a pore diameter range of 50 to 180 nm of 0.1 cm³/g or greater. On the other hand, the powder obtained in Comparative Example 1 has a ratio b/a of less than 0.9 and the powder obtained in Comparative Example 3 includes only Ti₄O₇ as a carrier, that is, is an electrode material free from nitrogen and has a cumulative pore volume in a pore diameter range of 50 to 180 nm of smaller than 0.1 cm³/g. Thus, the powders obtained in the comparative examples are both different from the electrode materials of the present invention.

Here, the reason why the powder obtained in Comparative Example 1 has a ratio b/a of less than 0.9 is presumably that anatase titanium oxide is used as a raw material.

Comparison of the area specific activities, which indicate oxygen reduction activity, of the powders having such differences shows that the powders obtained in Examples 1 to 3 have significantly higher area specific activity than the powders obtained in Comparative Examples 1 and 3, and have significantly greater specific surface area than the powder obtained in Comparative Example 3. In Comparative Example 3, the value of area specific activity was not measurable because it was smaller than the measurement limit value.

The powders obtained in Examples 4 and 5 are electrode materials each including a powdery composite compound composed of titanium, nitrogen, and oxygen as a carrier and having a ratio b/a of 0.9 or more and a cumulative pore volume in a pore diameter range of 50 to 180 nm of 0.1 cm³/g or greater. On the other hand, the powder obtained in Comparative Example 2 has a ratio b/a of less than 0.9 and a cumulative pore volume in a pore diameter range of 50 to 180 nm of smaller than 0.1 cm³/g. Thus, the powder is different from the electrode materials of the present invention. Comparison between these powders shows that the powders obtained in Examples 4 and 5 have significantly higher area specific activity than the powder obtained in Comparative Example 2.

Although not shown in the table, as a result of analysis of the metal elements other than Ti in the powder obtained in Example 1, the amount of the metal elements is found to be less than 0.2% by mass. The metal elements other than Ti and their amounts detected in the powder obtained in Example 1 are specifically 0.093% by mass of a Nb element and 0.071% by mass of a Si element.

Thus, the electrode material of the present invention is found to have high conductivity, high oxygen reduction activity, and excellent electrochemical properties.

1. An electrode material comprising a structure containing a noble metal and/or an oxide thereof supported on titanium oxynitride or a composite compound of titanium oxynitride and an oxide of titanium,
the titanium oxynitride or the composite compound of titanium oxynitride and an oxide of titanium being in the form of powder,
the electrode material having pore diameter distribution satisfying the following features (I) and (II):
(I) a ratio (b/a) of a peak area b in a pore diameter range of 50 to 180 nm to a peak area a in a pore diameter range of 0 to 180 nm, calculated from log differential pore volume distribution, being 0.9 or more, and
(II) a cumulative pore volume in a pore diameter range of 50 to 180 nm being 0.1 cm³/g or greater.

2. The electrode material according to claim 1,
wherein the noble metal is at least one metal selected from the group consisting of platinum, ruthenium, iridium, rhodium, and palladium.

3. The electrode material according to claim 1,
wherein the noble metal is platinum.

4. The electrode material according to claim 1, which is an electrode material for a polymer electrolyte fuel cell.

5. An electrode material composition comprising the electrode material according to claim 1.

6. A fuel cell comprising an electrode,
wherein the electrode comprises an electrode material comprising a structure containing a noble metal and/or an oxide thereof supported on titanium oxynitride or a composite compound of titanium oxynitride and an oxide of titanium,
the titanium oxynitride or the composite compound of titanium oxynitride and an oxide of titanium being in the form of powder,
the electrode material having pore diameter distribution satisfying the following features (I) and (II):
(I) a ratio (b/a) of a peak area b in a pore diameter range of 50 to 180 nm to a peak area a in a pore diameter range of 0 to 180 nm, calculated from log differential pore volume distribution, being 0.9 or more, and
(II) a cumulative pore volume in a pore diameter range of 50 to 180 nm being 0.1 cm³/g or greater
or the electrode material composition according to claim 5.

7. A method for producing an electrode material, comprising:
(1) firing a raw material containing rutile titanium oxide having a specific surface area of 20 m²/g or greater in an ammonia atmosphere; and
(2) supporting a noble metal and/or an oxide thereof using a product obtained in the step (1) and a noble metal and/or a water-soluble compound thereof.

8. The method according to claim 7,
wherein the step (1) further comprises firing in a reducing atmosphere.
